(19) United States
(12) Patent Application Publication
(10) Pub. No.: US 2010/0075231 A1
(43) Pub. Date: Mar. 25, 2010

(54) Lead Acid Battery Slurry Comprising Polyelectrolyte Comb Copolymers

(75) Inventors: Beth L. Armstrong, Clinton, TN (US); Glen H. Kirby, Liberty Township, OH (US)

Correspondence Address: UT-Battelle, LLC;Office of Intellectual Property, One Bethal Valley Road, 4500N, MS-6258, Oak Ridge, TN, 37831, US

(73) Assignee: UT-BATTELLE, LLC, Oak Ridge, TN (US)

(21) Appl. No.: 12/237,504

(22) Filed: Sep. 25, 2008

(51) Int. Cl. H01M 6/18; C08K 3/22

(52) U.S. Cl. 429/304; 524/430

(57) ABSTRACT

The invention provides a slurry, such as a lead-acid battery slurry, comprising a polyelectrolyte comb copolymer and lead oxide. Use of polyelectrolyte comb copolymers results in a slurry with low viscosity. In addition, the use of polyelectrolyte comb copolymers controls the growth (e.g., size, morphology and location) of the inactive species, and thus, improves battery cycle life.

### STATEMENT REGARDING FEDERALLY SPONSORED RESEARCH

The United States Government has rights in this invention pursuant to contract no. DE-AC05-000R22725 between the United States Department of Energy and UT-Battelle, LLC.

### BACKGROUND OF THE INVENTION

Conventional lead-acid batteries include a negative electrode (anode), a positive electrode (cathode), and an electrolyte medium. The anode supplies electrons to an external circuit (or load) during discharge and is typically composed of lead (Pb). The cathode accepts electrons from the external circuit (or load) during discharge and is generally composed of lead dioxide (PbO₂). The electrolyte medium completes the internal circuit in the battery by supplying ions to the negative and positive electrodes. A conventional lead-acid battery generally contains sulfuric acid as the electrolyte medium.

As the conventional lead-acid battery discharges, the active materials in the electrodes (e.g., lead dioxide in the positive electrode and lead in the negative electrode) react with sulfuric acid in the electrolyte to form lead sulfate and water. During recharge, the lead sulfate on both electrodes converts back to lead dioxide on the positive electrode and lead on the negative electrode, and the sulfate ions are driven back into the electrolyte medium to form sulfuric acid. The chemical reaction for a conventional lead-acid battery is depicted below:

At the positive electrode

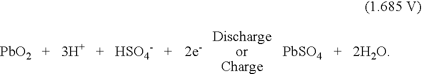

At the negative electrode

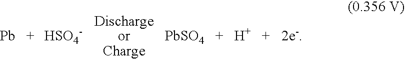

For the overall cell

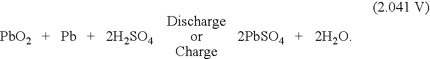

The planté plate method is generally utilized for constructing the negative electrode in a conventional lead-acid battery. A planté plate is generally a flat plate typically composed of pure lead. The capacity of a lead-acid battery is proportional to the surface area of the electrodes that is exposed to the electrolyte, planté plates are normally grooved or perforated to increase their surface area.

For the positive electrode, a conductive grid (e.g., porous substrate) is typically used. The conductive grid typically contains a lattice-network. To increase the surface area of the conductive grid, the active material (e.g., lead dioxide) is made into a paste (i.e., battery paste) and applied to the conductive grid so that the lattice of the grid is filled with the battery paste.

The battery paste is generally prepared by mixing an active material typically comprising finely divided lead oxide or a blend of oxides which may contain metallic lead in powder form and/or other additives with an aqueous solution of sulfuric acid at elevated temperature (e.g., 50-90° C.), then cured at 100% relative humidity at elevated temperature (e.g., 50-90° C.). The lead oxide undergoes partial dissolution to release lead (Pb²⁺) ions, which react with sulfate ions in solution to form a mixture of monobasic lead sulfate (1BS, PbO.PbSO₄), tribasic lead sulfate (3BS, 3PbO.PbSO₄.H₂O) and tetrabasic lead sulfate (4BS, 4PbO.PbSO₄). The relative amount of each lead sulfate phase depends of the lead oxide to sulfuric acid ratio, the mixing/curing temperature, and the phase of the PbO precursor (alpha or beta).

Lead-acid battery paste, however, is extremely viscous. Thus, the battery manufacturing industry generally utilizes lead based electrodes of simple geometry so that the paste can fill the lattice of the conductive grid. However, such batteries are of substantial weight.

In order to manufacture lightweight batteries, lightweight electrodes, such as graphite fiber weaves, a low viscosity battery paste is necessary in order to ensure infiltration of the lead acid battery paste into the electrode weaves and capitalize on the high surface area available. Thus, there is a need for a lead acid battery paste with low viscosity.

In addition, as a result of reversible electrochemical reactions at both the anode and cathode, an “inactive material” (e.g., lead sulfate) forms and dissolves due to battery discharge and charge. In the absence of expanders, a large volume change occurs with the formation and dissolution of inactive materials, which promotes mechanical degradation of the interface between the paste materials and the grids, and/or cohesive failure of the lead-acid battery paste. Exfoliation of the battery paste is considered the life-limiting factor in lead-acid batteries. Thus, there is also a need for a lead acid battery paste that does not suffer from the drawbacks of conventional lead-acid battery paste.

### BRIEF DESCRIPTION OF THE FIGURES

FIG. 1. Apparent viscosity as a function of shear stress for PbO suspensions of constant polyelectrolyte comb copolymer concentration (10 mg PAA-PEO/g PbO) and vary PbO volume fraction: 0.10 (∘), 0.20 (□), 0.25 (r), 0.30 (^{—}), 0.35 (s), 0.40 (v), 0.45 (w), 0.50 ( [symbol] ), 0.525 (Í). The inset is a plot of the apparent viscosity (i.e., the minimum value) as a function of PbO volume fraction

FIG. 2. Apparent viscosity as a function of shear stress for PbO suspensions of constant PbO volume fraction (fPbO=0.25), constant expander concentration (10 mg expander/g PbO), and varying expander type: PAA-PEO (,∘), lignin (p,r), and PSA (▪,□). Data for PbO suspensions in the absence of expander (u,^{—}) are also shown for comparison. The closed and open symbols indicate PbO suspensions in the absence and presence of 50 mg H2SO4/g PbO. The solid lines merely guide the eye

### SUMMARY OF THE INVENTION

These and other objectives have been met by the present invention, which provides, in one aspect, a slurry composition comprising a polyelectrolyte comb copolymer and lead oxide.

In another aspect, the invention provides a lead-acid battery slurry comprising a polyelectrolyte comb copolymer and lead oxide.

In a further aspect, the invention provides a lead-acid battery comprising an (i) anode, (ii) a cathode comprising a slurry containing a polyelectrolyte comb copolymer and lead oxide, and (iii) an electrolyte.

As a result of the present invention, a slurry is provides, such as a lead-acid battery slurry. The slurry comprises a polyelectrolyte comb copolymer and lead oxide. Use of polyelectrolyte comb copolymers results in a slurry with low viscosity. In addition, the use of polyelectrolyte comb copolymers controls the growth (e.g., size, morphology and location) of the inactive species, and thus, improves battery cycle life.

For a better understanding of the present invention, together with other and further advantages, reference is made to the following detailed description, and its scope will be pointed out in the claims.

### DETAILED DESCRIPTION OF THE INVENTION

The present invention is based on the surprising discovery by the inventors that the use of polyelectrolyte comb copolymers, as dispersants, results in a slurry composition with lower viscosity than that of conventional lead-acid battery paste. In addition, use of polyelectrolyte comb copolymers, as an expander, controls the growth (e.g., size, morphology and location) of the inactive species, and, improves battery cycle life.

In one aspect, the present invention provides a slurry composition comprising a mixture of a polyelectrolyte comb copolymer and lead oxide. Comb copolymers are copolymers that have a backbone of one polymer chain and teeth or bristles of another polymer chain. The teeth or bristles of the comb copolymers are typically referred to as side chains. Comb copolymers are also known as brush copolymers. The term comb copolymer is used herein for convenience, and includes brush copolymer.

Throughout this specification, parameters are defined by maximum and minimum amounts. Each minimum amount can be combined with each maximum amount to define a range.

The minimum overall molecular weight of the comb copolymer is at least about 1,000 grams/mole, more preferably at least about 5,000 grams/mole, and most preferably at least about 20,000 grams/mole. In one embodiment, the comb copolymer is used primarily as a dispersant and the maximum overall molecular weight of the comb copolymer is at most about 50,000 grams/mole. In another embodiment, the comb copolymer is used like a traditional extender where the excluded volume occupied by the large, absorbed polymer gives space for crystallizing lead sulfate species to form without introducing high stresses leading to cohesive failure within the battery paste. In this embodiment, the molecular weight at most is about 10,000,000 grams/mole.

The “backbone” of the comb copolymer is a collection of polymerized monomer units attached to one another. The attachment is typically achieved by covalent bonding. However, other types of chemical bonds, such as ionic bonds, van der Waals forces, etc. are also possible. The minimum number of monomer units in the backbone is at least about 10, more preferably at least about 25, and most preferably at least about 50. In one embodiment, the comb copolymer is used primarily as a dispersant and the maximum number of monomer units in the backbone is at most about 100, more preferably at most about 75 monomer units. In another embodiment the comb copolymer is used like a traditional extender where the excluded volume occupied by the large, adsorbed polymer gives space for crystallizing lead sulfate species to form without introducing high stresses capable of causing cohesive failure within the battery paste. In this embodiment, the number of backbone monomer units is at most about 140,000.

Polymer chains useful in the backbone of a comb copolymer comprise an ionizable polyelectrolyte. Any ionizable polyelectrolyte can be used in the backbone of the comb copolymer. The term “polyelectrolyte” as used herein refers to a polymer whose repeating monomer units contain an electrolyte group. An electrolyte is a substance that contains ionizable or protonizable groups. Ionizable groups may include but are not limited to carboxylic acid groups, hydroxycarboxylic acid groups, sulfonic acid groups, and phosphonic acid groups. Oppositely charged ions, known as counterions, are ionically bonded to the ionizable groups. Examples of couterions include (but are not limited to): hydrogen (H⁺), sodium (Na⁺), potassium (K⁺), calcium (Ca²⁺), magnesium (Mg²⁺), strontium (Sr²⁺), barium (Ba²⁺), lead (Pb²⁺), etc. Protonizable groups are typically amine groups (NH) that gain hydrogen to become NH₂⁺.

The electrolyte group of the polyelectrolyte typically dissociates in an aqueous solution (e.g., water), thereby resulting in a charged polymer. The polyelectrolyte can be negatively or positively charged when dissociated or protonated, respectively. Polyelectrolytes that are negatively charged upon dissociation in water are known as anionic polyelectrolytes. Polyelectrolytes with, for example, amine groups that become protonated in water, and thus, become positively charged are known as cationic polyelectrolytes. Some polyelectrolytes contain both ionizable (negatively charged) and protonizable (positively charged) groups and are referred to as zwitterionic. Zwitterionic polyelectrolytes can also be used in the present invention.

The polyelectrolyte can be a synthetic or biological molecule. Examples of synthetic ionizable polyelectrolytes include, but are not limited to, polyacrylic acid, polymethacrylic acid, polyethylenimine, polysulfonic acid, polysodium styrene sulfonate, polyaminoamides, poly(diallyldimethylammonium chloride), poly(dimethylamine-co-epichlorohydrin), poly(methacryloyloxyethyltrimethylammonium chloride), poly(methacryloyloxyethyldimethylbenzylammonium chloride, poly(vinylimidazole), poly(vinylpyridine), poly(vinylamine), sulfonated naphthalene formaldehyde condensate and lignosulfonates. Examples of biological ionizable polyelectrolytes include, but are not limited to polyamino acids having a net positive or net negative charge at neutral pH, such as polylysine, polyomithine, polyarginine, polyhistidine, polyglutamic acid, and polyaspartic acid, and positively or negatively charged polysaccharides, such as chitosan, partially deacetylated chitin, xanthan gum, cellulose and cellulose derivatives, and amine-containing derivatives of neutral polysaccharides.

The “side chain” (e.g., teeth or bristles of the comb copolymer) of the comb copolymer is a collection of polymerized monomer units attached to one another. The attachment is typically achieved by covalent bonds. Polymer chains useful in the side chains of the comb copolymer are neutrally charged polymers. The side chain can be a synthetic or biological molecule.

In one embodiment, both the backbone and the side chains are synthetic molecules. Alternatively, both the backbone and the side chains are biological molecules. In yet another embodiment, the backbone is a synthetic molecule and the side chains are biological molecules. Alternatively, the backbone is a biological molecule and the side chains are synthetic molecules.

Examples of suitable synthetic neutrally charged polymers for use as side chains include polyethylene glycol, polyethylene oxide, polypropylene oxide, partially or fully hydrolyzed polyvinyl alcohol, and polyvinylpyrrolidone. Examples of suitable neutrally charged biological polymer molecules include polyamino acids having a neutral charge at neutral pH, such as polyglycine, polyleucine, polymethionine, etc., and neutrally charged polysaccharides, such as dextran. In a preferred embodiment, the neutrally charged polymer is polyethylene oxide.

The number of monomer units in each side chain of the comb copolymer can be the same. For example, all of the side chains for a given backbone can have the same number of monomers. Alternatively, the number of monomer units in each side chain for a given backbone can vary.

The minimum number of monomer units in each side chain is at least about 2, more preferably at least about 5, and most preferably at least about 15. In one embodiment, the comb copolymer is used primarily as a dispersant and the maximum number of monomer units in the side chain is at most 100 and more preferably, at most about 75 monomer units. In another embodiment the comb copolymer is used like a traditional extender where the excluded volume occupied by the large, adsorbed polymer gives space for crystallizing lead sulfate species to form without introducing high stresses capable of causing cohesive failure within the battery paste. In this embodiment, the number of backbone monomer units is at most about 250,000.

Side chains are attached to the backbone by a chemical bond. Typically, the attachment is achieved by covalent bonding. Covalent bonding is achieved by attachment to specific linking groups located within the polyelectrolyte backbone. The linking groups for example, may be an imide group or an ester group located among the polyelectrolyte monomer units in the backbone chain. The ratio of linking monomers to electrolyte monomers is at least 20:1, more preferably 10:1, and most preferably 7:1.

The minimum amount of the polyelectrolyte comb copolymer in the slurry is at least about 0.01 w/w % (weight of copolymer/weight of lead oxide) and more preferably at least about 0.2 w/w %. The maximum amount of the polyelectrolyte comb copolymer in the slurry is at most about 33 w/w % and more preferably at most about 3.0 w/w %.

Methods for synthesizing comb copolymers are know to those in the art. Any method can be utilized. For example, the comb copolymers can be prepared by copolymerizing an ionizable polyelectrolyte with a neutrally charged polymer. Alternatively, a neutrally charged polymer can be grafted to an ionizable polyelectrolyte backbone.

The lead oxide suitable for use in the slurry of the present invention can be any form of lead oxide. Examples of lead oxide include PbO, PbO₂, and Pb₃O₄, and combinations thereof. In a preferred embodiment, the lead oxide is lead dioxide. The lead oxide can comprise free lead ions.

The lead oxide can be produced by any method known to those in the art. For example, the ball mill process can be utilized. Briefly, in this process, lead pigs, or ingots are charged with air into a ball mill. Frictional head generated by the tumbling lead ingots initiates the oxidation reaction. Oxygen in the air, assisted by the heat of the tumbling lead, reacts with the lead to produce lead oxide. During milling, the lead oxide that forms on the surface of the ingots and fine particles of un-oxidized lead are broken off, forming a fine dust that is removed from the mill by a circulating air stream.

Other methods, such as the Barton-Like Process can be utilized for producing lead oxide. In this process, lead ingots are first melted and then fed into a vessel or pot, where the molten lead is rapidly stirred and atomized into small droplets. The droplets of molten lead are then oxidized by air drawn through the pot and conveyed to a product recovery system which typically comprises a settling chamber, cyclone, and baghouse.

The minimum amount of lead oxide in the slurry is at least about 1 vol % and more preferably, the at least about 10 vol %. The maximum amount of lead oxide in the slurry is at most 60 vol %, and more preferably at most about 52.5 vol %.

The slurry composition of the present invention can optionally contain an acid. Any acid can be used in the slurry composition. Examples of suitable acids include sulfuric acid, hydrochloride acid, nitric acid, phosphoric acid, hydrobromic acid, chromic acid, methanesulfonic acid, ethanesulfonic acid, benzenesulfonic acid, toluenesulfonic acid, and combinations thereof. Other examples of suitable acids include acetic acid, citric acid and tartaric acid. In a preferred embodiment, the acid is sulfuric acid.

The acid can be in the form of an aqueous solution. The term “aqueous solution” as used herein refers to a solution in which the solvent is water. The concentration of the acid solution is typically at most about 20 M. For example, the concentration of the acid can be about 18 M.

The slurry composition of the present invention can contain at most about 15 w/w % (weight of anhydrous acid per weight of lead oxide) acid. In one preferred embodiment, the slurry composition contains about 5 w/w % acid.

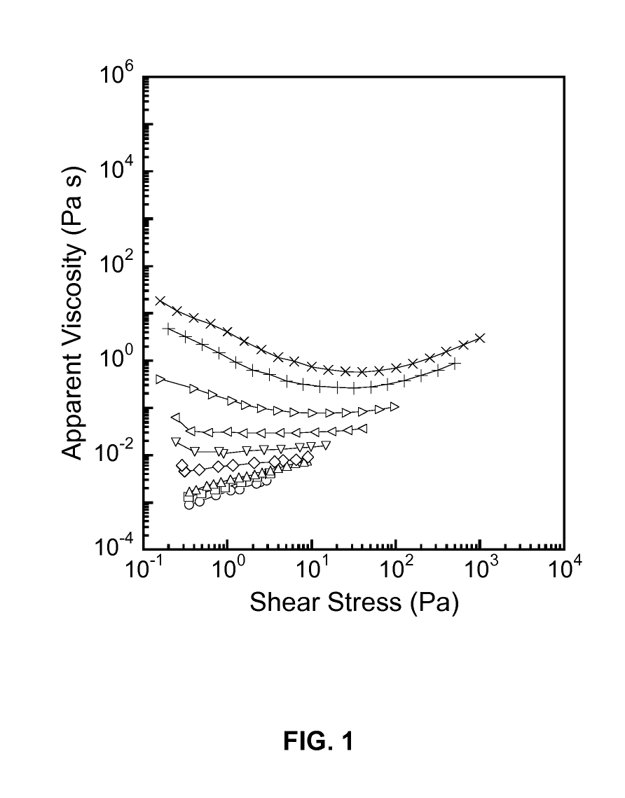

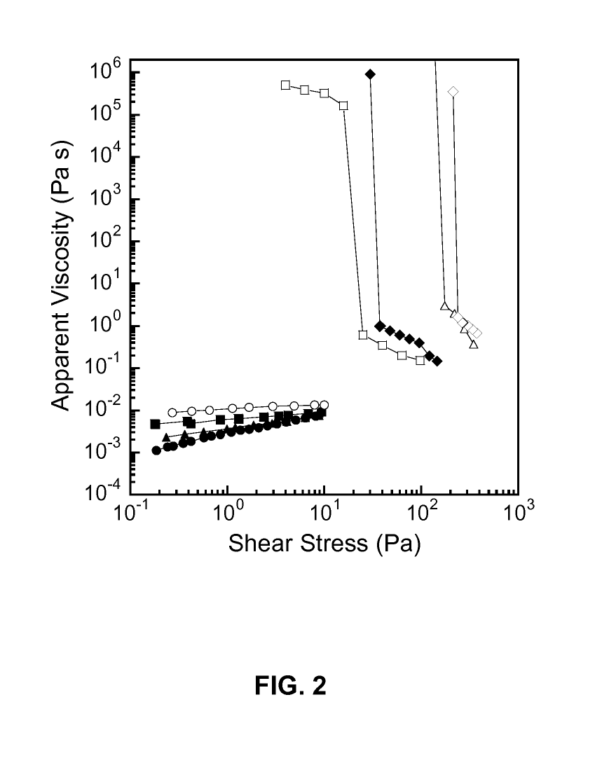

Use of the comb copolymers provides the capability of using slurry compositions of varying lead oxide content having low viscosity (0.0005-100 Pa s) over a broad range of applied shear stress (0.1 Pa-1000 Pa) (see FIG. 1). Furthermore, the comb copolymers reduce shear-thinning flow behavior of battery paste, particularly in the presence of the sulfuric acid, which promotes gelation of battery pastes with traditional expanders like lignin (see FIG. 2). The low viscosity of the slurry composition of the present composition makes it especially suitable for use as a lead-acid battery paste. In particular, the low viscosity of the slurry composition can be used in manufacturing lightweight electrodes for lightweight batteries.

In addition, use of polyelectrolyte comb copolymers control the growth of the inactive species, and, improves battery cycle life. Instead of strong crystallographic growth of inactive species leading to large volume changes, the comb polymer promotes slow, uniform growth of inactive species in all directions. The resulting inactive phase is less “platelike” or “needlelike” in morphology, which results in lower volume change preventing cohesive failure of the battery paste.

In another embodiment, the comb copolymer promotes separation between adjacent lead oxide particles so that the inactive species can grow within this excluded volume. With enough “excluded volume”, the paste can accommodate large volume changes do to growth of the inactive phase.

In another aspect, the present invention provides a lead-acid battery. The lead-acid battery comprises an anode, a cathode, and an electrolyte. The anode and the electrolyte, of the lead-acid battery of the present invention, are not critical, and form no part of the invention, and can be any lead-acid battery anode and electrolyte known to those skilled in the art.

For example, the anode of a conventional lead-acid battery is generally comprised of a current collector grid. The collector grid can be, but is not limited to, lead-antimony alloys, lead-calcium alloys, graphite foam and woven carbon fibers. The electrolyte in a conventional lead-acid battery is generally a dilute sulfuric acid solution. In a fully charged conventional lead-acid battery, the electrolyte is approximately 25% sulfuric acid and 75% water.

The cathode of the lead-acid battery of the present invention comprises the slurry composition described above. The slurry composition is typically deposited onto a conductive grid. Any conductive grid known to those in the art can by utilized. For example, the conductive grid can comprise, but is not limited to, polyethylene, polypropylene, polyester, fluorocarbons, lead alloy, graphite foam, carbon fibers, silicon carbide, silicon, and other semiconductive material.

Other examples of materials suitable for conductive grids include precious metal-coated conductive grids. Examples of precious metals useful in the precious metal-coated conductive grids include gold, silver, platinum, ruthenium, rhenium, palladium, rhodium. The precious metal can, for example, be coated on a lightweight grid. The lightweight grid can comprise, for instance, glass fibers, silicon carbide fibers and polymer fibers such as nylon, Teflon, etc.

Thus, while there have been described what are presently believed to be the preferred embodiments of the invention, changes and modifications can be made to the invention and other embodiments will be know to those skilled in the art, which fall within the spirit of the invention, and it is intended to include all such other changes and modifications and embodiments as come within the scope of the claims as set forth herein below

### EXAMPLES

### Example 1

### Slurry Fabrication

Slurries were fabricated as follows. Deionized water and the additive at concentration of 10 mg per gram PbO was added to a plastic (Nalgene or unreactive material) bottle and mixed through either use of a shaker, a mixer or a ball mill. Sulfuric acid at a concentration of 50 mg per gram of PbO is subsequently added to the water and comb polymer mixture and mixed again. Once the sulfuric acid is incorporated into the water-comb copolymer mixture, PbO is added at the desired solids loading. The resulting final mixture combination of water, comb copolymer, sulfuric acid and PbO is milled for four hours on a ball mill. The milled suspension is placed in an oven at 85° C. for 48 hours. This curing step forms 3BS. The cured suspension is removed from the oven and allowed to cool to room temperature. Once cooled, the weak particle gel that is formed during curing needs to be broken through either shaking, stirring, or slow milling. The resulting suspension may be used immediately or stored for use at a later time.

### Example 2

### Coating Fabrication

The cured suspension from Example 1 is poured into a vessel big enough to allow the desired coated shape to be dipped in without touching the walls of the vessel. The shape to be coated is dipped into the slurry and retracted. This can be done manually or an automated procedure can be used. The coated shape is subsequently dried.

### Example 3

### Evaluation of Viscosity as a Function of Shear Stress with Constant Comb Copolymer Concentration and Varying PbO Solids Loading

Using the procedure described in Example 1, eight slurries are made where the comb copolymer is used and held constant at 10 mg per gram of the PbO. The PbO concentration is varied in each slurry formulation. The first slurry is made where the PbO volume fraction is 10% (0.1). The second slurry is made where the PbO volume fraction is 20% (0.2). The third through the eighth slurries are made where the PbO volume fractions are 25 (0.25), 30 (0.30), 35 (0.35), 40 (0.40), 45 (0.45), 50 (0.50), and 52.5 (0.525) %, respectively. The viscosity of the eight individual slurries is measured on a controlled-stress rheometer fitted with a concentric cylinder geometry. Shear stress across a wide range (10⁻¹ to 10³ Pa) is varied and the resulting viscosity measured and plotted. The resulting data (FIG. 1) shows that low viscosity values (0.001-20 Pa s) and nearly Newtonian flow behavior occurs over the entire range of PbO volume fractions evaluated.

### Example 4

### Evaluation of Viscosity as a Function of Shear Stress for PbO Suspensions with Constant PbO and Additive Concentration and Varied Additive Type

Using the procedure described in Example 1, three slurries are made where the additive concentration is held constant at 10 mg per gram of the PbO. The PbO concentration is also held constant at 0.25 volume fraction. The additive type is varied and includes the comb copolymer, lignin, and poly(vinyl sulfonic acid). The first slurry is made where the PbO additive is the comb copolymer. The second slurry is made where the additive is lignin, and the third slurry is where the additive is poly(vinyl sulfonic acid). For comparison purposes, an additional (fourth) slurry is made in the absence of additives. The viscosity of the four individual slurries is measured on a controlled-stress rheometer fitted with a concentric cylinder geometry. Shear stress across a wide range (10⁻¹ to 10³ Pa) is varied and the resulting viscosity measured and plotted. Four additional slurries are made using the general procedure described above and the same additives omitting the addition of the sulfuric acid. The resulting data shows that all additives are useful to improve the flow behavior of the PbO suspensions in the absence of sulfuric acid. The comb copolymer is superior to the traditional battery additives (lignin) and linear polymers (poly(vinyl sulfonic acid) in the presence of sulfuric acid. See FIG. 2.

What is claimed is:

1. A slurry composition comprising a polyelectrolyte comb copolymer and lead oxide.

2. A slurry according to claim 1, wherein the polyelectrolyte comb copolymer is polyacrylic acid-polyethylene oxide.

3. A slurry according to claim 1, wherein the lead oxide comprises lead monoxide.

4. A slurry according to claim 1, wherein the lead oxide comprises lead dioxide.

5. A slurry according to claim 1, wherein the lead oxide comprises free lead ions.

6. A lead-acid battery slurry comprising a polyelectrolyte comb copolymer and lead oxide.

7. A lead-acid battery slurry according to claim 6, wherein the polyelectrolyte comb copolymer is polyacrylic acid-polyethylene oxide.

8. A lead-acid battery slurry according to claim 6, wherein the lead oxide comprises lead monoxide.

9. A lead-acid battery slurry according to claim 6, wherein the lead oxide comprises lead dioxide.

10. A lead-acid battery slurry according to claim 6, wherein the lead oxide comprises free lead ions.

11. A lead-acid battery comprising:
a. an anode,
b. a cathode, wherein said cathode comprises a slurry comprising a polyelectrolyte comb copolymer and lead oxide, and
c. an electrolyte.
